(19) United States
(12) Patent Application Publication
(10) Pub. No.: US 2024/0426169 A1
(43) Pub. Date: Dec. 26, 2024

(54) DEVICE TO MANAGE ENVIRONMENTAL CONDITION OF SECONDARY WINDOW

(71) Applicant: Alpen High Performance Products, Inc., Louisville, CO (US)

(72) Inventors: Will Shatford, Littleton, CO (US); Gary Warren Carmichael, Boulder, CO (US)

(21) Appl. No.: 18/750,551

(22) Filed: Jun. 21, 2024

Related U.S. Application Data
(60) Provisional application No. 63/628,127, filed on Jun. 23, 2023.

(51) Int. Cl. E06B 7/10; E06B 7/02; E06B 7/12; F24F 7/007; F24F 11/00; F24F 13/22; F24F 110/10; F24F 110/20

(52) U.S. Cl. CPC E06B 7/10; E06B 7/12; F24F 7/007; F24F 11/0001; E06B 2007/023; E06B 2007/026; F24F 2013/221; F24F 2110/10; F24F 2110/20

(57) ABSTRACT

A device may include a first temperature/humidity sensor positioned on a room-side surface of the housing to sense a first temperature and a first relative humidity of ambient air within a room; a second temperature/humidity sensor within the cavity to sense a second temperature and a second relative humidity of air within the cavity; and a glass temperature sensor positioned on an internal surface the primary window to sense a third temperature of the glass. The device may include a first vent within the housing to allow the ambient air to draw in by a fan into the cavity. The device may include a second vent within the housing to allow the air within the cavity to pass to the room. A controller within the housing may read the first temperature, the first relative humidity, the second temperature, the second relative humidity, and the third temperature and activate the fan.

### CROSS-REFERENCE TO RELATED APPLICATIONS

This application claims priority to, and benefits from, U.S. Provisional Patent Application Ser. No. 63/628,127, filed Jun. 23, 2023. The entire disclosure of the aforementioned application is incorporated by reference herein as if fully set forth.

### BACKGROUND

Many older commercial and residential buildings still have their original single-pane windows, which provide far inferior thermal insulation compared to new replacement windows. While single-pane windows increase heating and/or cooling costs for such buildings, replacing the single-pane windows with newer energy-efficient windows can be cost-prohibitive. For example, recouping the cost of new windows with lower energy bills may take decades. Furthermore, replacing original windows may be undesirable for aesthetic reasons, e.g., for historical buildings, for which building codes may also prohibit modification of the building's external appearance.

Replacing existing windows can be very expensive and alternative methods are being explored. One method is to place another window adjacent to the existing window, creating a gap between the windows, and effectively making it a double-pane window. Or, even place another double pane window adjacent to the existing window to make a triple-pane window. The added window could also include films, which are much easier to add to new windows, to further improve the performance.

Co-owned U.S. Pat. No. 11,008,800 titled “Secondary Window” is incorporated by reference in its entirety for disclosure purposes, teaches of adding a secondary window, also known as window insert, to a building's existing window, known as a primary window, to provide an alternative to window replacement. The secondary window may be installed adjacent to the interior side of the primary window.

### SUMMARY

Secondary windows are designed to be installed inside of an existing window and while maintaining the primary window in place. However, the secondary window forms a new enclosed cavity, or chamber, between the primary window and the secondary window with a risk that humidity within the new enclosed cavity may be higher than ambient interior office air under certain conditions. In other conditions, even with a humidity in the cavity like the humidity of the interior office air, the secondary window will isolate the inside surface of the primary window from the warmer office air, and in conditions of cold outside air the colder inside surface of the primary window may experience condensation whereas before the installation of the secondary window it did not. The new cavity may cause two other conditions to occur as well. For example, in conditions with higher external solar loads, heat may build up in the cavity and create thermal stress on the primary window and secondary window. These stresses may cause damage to the both primary and secondary windows, such as cracking, damage to any films applied to the windows, and damage to any sealers of the windows. This heat buildup may also cause increased pressure inside the cavity which may push the secondary window out of its installation.

A goal of the secondary window is to add insulation to the primary window, which is accomplished by including a single pane or a double pane in the secondary window, as described in U.S. Pat. No. 11,008,800. However, where outside temperatures are colder than temperatures inside a building, such as when the building is heated, the added insulation may cause the primary window glass temperature, particularly at an inside surface, to drop because the primary window glass is no longer directly exposed to heat from the inside of the building. That is, some of that heat from inside the building is blocked from reaching the primary window glass by the secondary window and therefore the primary window glass temperature is lowered. It can be lowered more than previously experienced because the primary window was exposed directly to the warmer interior building air.

In certain conditions, this lower primary glass temperature can cause the dew point of the inside of the primary glass to reach points where condensation can temporarily appear inside the improved window condition.

In some cases, the exiting primary window may not be adequately sealed and outside air can leak into the cavity formed between the primary and secondary windows. Before the addition of the secondary widow this leakage may have not been of much concern because the air could be well mixed with the interior building air. In some cases the outside air could be of a higher relative humidity than exists in the building and the leakage of this air into the cavity will increase the humidity in the cavity.

In certain conditions, the lower primary glass temperature combined with possibly higher cavity humidity can cause the dew point of the inside of the primary glass to increase to reach points where condensation can temporarily appear inside the improved window condition.

There exists a need to reduce the risk of condensation, or at least the concern that condensation could be created between the secondary window and primary window. This need includes improving existing windows to improve the overall rating of the window, and thereby make a room or entire building more energy efficient. No one has invented a mechanical device to recognize when the conditions for risk occur is present and then cause short term increase in cavity temperature and/or lower humidity to occur by turning a fan on when triggered by a computer program to pull in warmer, and possibly lower humidity, air inside the office into the cavity and evacuating colder, and possibly higher humidity, air to leave the cavity.

The device contemplated herein has a small fan, valves (such as duckbill valves) either permitting air to come in one way or leave the cavity one way (in embodiments there is a simple barrier built into separate the two valves to avoid cross over inside the device), small humidity and temperature sensors located inside and outside of the cavity to read those conditions into a computer program (the temperature sensor to the inside of the newly enclosed cavity is extended with a gentle tension to stay in contact with the inside surface of the primary window to read that surface temperature to be input into the application/program. The computer program is designed and can be added to a circuit board located inside the device and that, and fan, can be powered by batteries that can be recharged either with solar strips or by a plug-in charging port. The circuit board and fan can be permanently connecting to a power source. These power sources can be daisy-chained to adjacent windows to power the circuit boards and fans in those windows. The circuit board is wired to each sensor and the fan and is integrated into the device. This combination of circuit board, sensors, and fan can be referred to as the system.

The computer program is designed to understand the combinations of conditions (temperature and humidity) that exist to lead to condensation and when to trigger the fan. The program uses an advance formula to determine dew point, the temperature at which condensation can occur, that is accurate for a broad range of humidity. The program also uses a unique formula to the measure the total water-mass inside the cavity and in the office. Water-mass comparisons between the cavity and office air will also be used as a determination for turning on the fan. The computer program will also determine when the temperature of the primary glass is dropping rapidly and will anticipate possible condensation conditions and will turn on the fan in advance of those conditions. The same system can also be used to simply manage thermal heat build up to trigger an exchange of colder interior conditioned office air and evacuation of higher temperatures in the office space.

No combination of devices has been designed to be used with secondary windows to mechanically solve the risks identified. Embodiments of the systems and methods herein are used with and/or placed in the rail of the gasket of the window insert. To reduce cost, it is not installed with every window insert, but only in those windows that have experienced condensation. And the new rail with the systems and methods herein can be easily installed in the field to an existing window insert.

By incorporating the embodiments herein into window inserts (also referred to as “secondary windows”), the embodiments will replace the higher humidity air in the gap between the exiting window and the window insert with the lower humidity air of the room to thereby reduce the dewpoint of the air in the gap and, thereby reducing the temperature at which condensation will occur. As such, the embodiments disclosed herein reduce the accumulated relative humidity (humidity or RH) inside the cavity thereby lowering the dew point below the temperature inside the cavity, and/or raising the cavity temperatures affectively raising the temperature of the cavity above the dew point.

The device including all of the above is designed to be housed in an existing WinSert® (manufactured and sold by Alpen HPP, Inc.) frame dimensions and can be used as an add on to the top or bottom of the WinSert® frame or can be built into the WinSert® frame itself. It should be appreciated that the device(s), system(s), and method(s) can be applied in other secondary windows without departing from scope hereof.

### BRIEF DESCRIPTION OF THE FIGURES

FIG. 1 is a schematic illustrating an environmental control device configured with a secondary window that fits on or within a frame of a primary window, in embodiments.

FIG. 2A shows the environmental control device of FIG. 1 integral with the secondary window, which is mounted to the frame of the primary window within the wall, in embodiments.

FIG. 2B shows the environmental control device of FIG. 1 configured within a housing joined to a bottom side of the secondary window, in embodiments.

FIG. 3 is a cross-section through a portion of the environmental control device of FIGS. 1 and 2A, showing a cavity formed between the glazing of the primary window and the glazing of the secondary window, in embodiments.

FIG. 4 is a perspective image showing a room-side surface of the environmental control device of FIG. 2B, in embodiments.

FIG. 5 is a perspective image showing a cavity-side surface of the environmental control device of FIG. 2B, in embodiments.

FIG. 6 is a schematic showing example connectivity of the room-side temperature/humidity sensor, the cavity-side temperature/humidity sensor, the glass temperature sensor, and the fan to a controller, in embodiments.

FIG. 7 is a flowchart illustrating one example method for controlling humidity within the cavity formed between the primary window and the secondary window of FIG. 1, in embodiments.

### DETAILED DESCRIPTION OF THE EMBODIMENTS

The present embodiments address the above-described problems of actual or contemplated condensation by mitigating the risk of condensation in secondary window installations by reducing the accumulated relative humidity (humidity or RH) inside the cavity thereby lowering the dew point below the temperature inside the cavity, and/or raising the cavity temperatures affectively raising the temperature of the cavity above the dew point.

This is accomplished by a program in an integrated computer (microprocessor) constantly monitoring the “office air” (temperature and relative humidity (humidity or RH)) and comparing it with the “cavity air” (temperature and humidity). At preset differentials the computer will signal a fan to turn on and force the “office air” (warmer, and potentially dryer, air or air otherwise obtained from the interior of the structure to which the window is installed) into the cavity through a vent while existing air is flushed out through a vent. The preset differential may be adjusted by the program to account for a rapidly decreasing temperature of the inside surface of the primary window to preemptively avoid condensation on this surface.

The dew point is the temperature at which condensation will typically occur. This dew point is determined by the humidity of the air based on the Equation (1), below. Other formulas may be used to calculate dew point as well. However, Equation (1) has been shown to be particularly accurate at below 50% humidity.

$$Dew point = ( 243.12 * ( In ( \frac{humidity}{100.} ) + ( \frac{17.62 * temperature}{243.12} + temperature ) ) ) / ( 17.62 - ( In ( \frac{humidity}{100.} ) + ( \frac{17.62 * temperature}{243.12 + temperature} ) ) ) ) \qquad Equation ( 1 )$$

To lower the dew point, the relative humidity, and, therefore, the amount of moisture in the air in the gap must be lowered. The maximum water-mass in saturated air is based only on the temperature. This is the temperature at below which condensation will occur. This formula has been simplified for use at sea level, but will be shown this is not critical. The actual water-mass in the air is then based on the humidity percentage. The temperature is in degrees Kelvin. The results at in g/m3, although just the difference between the gap air and room air is important. To determine the water-mass in the air, the following Equation (2) and Equation (3) may be used in the system(s) and method(s) herein. Other formulas may be used to calculate water-mass as well.

$$MaximumWaterMass = ( power ( 10 , double ( 5.20389 - \frac{1733.926}{temperature - 39.486} ) ) * \frac{100000}{8.314 * tempearture} * 18.02 \qquad Equation ( 2 )$$

$$WaterMass = MaximumWaterMass * humidity / 100 \qquad Equation ( 3 )$$

Using the water-mass formula provides an improved advantage of lowering the dew point in the cavity when the water-mass in the office is lower than the water-mass in the cavity.

In embodiments of the systems and methods herein, periodically the temperature and humidity of the gap air and the room air may be measured. The glass S2 surface temperature may also be measured. Under certain conditions, described below, a small fan in the rail gasket may be turned on to push room air into the gap. The rail gasket vents will be fitted with filters so that dust and moisture cannot be pushed into the gap, and so that gap air can freely exit into the room.

Under certain conditions when the water-mass of the room air is lower that the water-mass in the gap, the fan in the systems and methods herein is turned on. Even though the water-mass formula is based on sea level, the water-mass differences between the gap and room are relative, and the formula still applies.

In order to save energy, this simple delta in water-mass does not always mean the fan needs to be turned on. If the dew point in the gap is substantially lower that the temperature of the S2 surface, then the fan does not need to be turned on. But, if over several measurements, the S2 temperature is dropping, meaning the outdoor temperature is dropping or the glass is going into shade, then as a preemptive measure the fan will be turned on if it is determined that the trend in the temperature drop may cause condensation. And, if the humidity in the gap reaches a level that is substantially higher than the air in the room, as a simple preventative measure then the fan will be turned on.

The fan may be cycled on for a short period and then turned off. After a short period, giving the gap conditions time to stabilize, measurements will be taken to see if additional cycles of the fan are required. Testing of the systems and methods herein has shown that the water-mass replacement required to eliminate, or prevent, condensation may take only 30 minutes. This is a significant advantage in the usefulness of the secondary windows when the systems and methods are included therein.

As an added advantage of the systems and methods herein, pressure caused by hot air in the gap will be vented out through the gap filter. This heating of air in the gap is well known and caused by direct sunlight on the window. The stress from this pressure can be high enough to crack glass in multi-pane windows, may affect the gasket of the window insert, or even push the window insert off the assembly, so venting is a good advantage. It will also help to reduce the water-mass in the gap.

There may be times when the water-mass in the room could be higher than that in the gap. The venting mentioned above may be one of the reasons. Issues with the office control systems may also cause this condition.

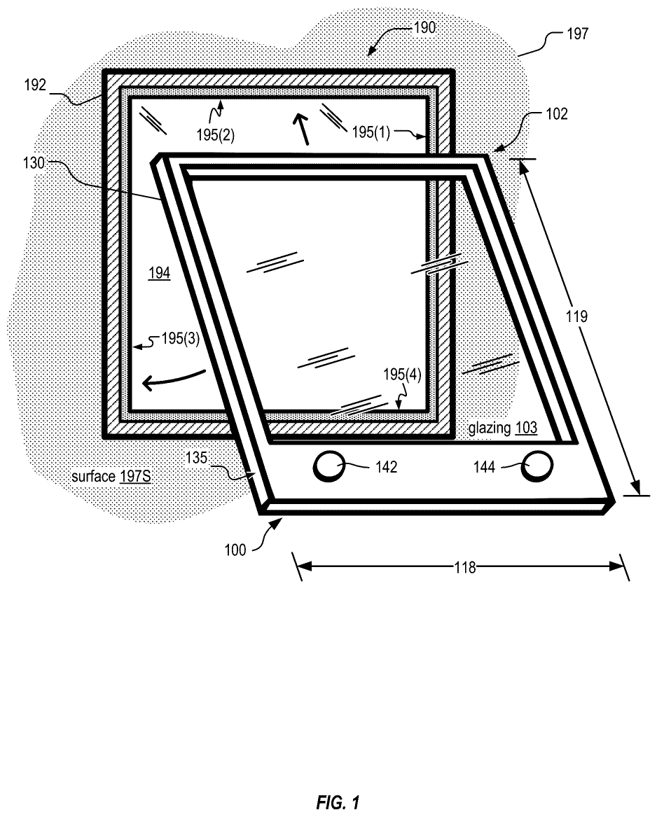

The systems and methods herein may be able to communicate through Wi-Fi and Bluetooth (or other wired or wireless communication protocols, such as cellular 2G, 4G, 5G, LTE, IoT-NB, Zigbee, ethernet, etc.) with the office automation system to report conditions in the room, the gap, and the S2 surface. Gateways are available to convert this communication to common office automation systems. At least some embodiments of the systems and methods herein can also receive information and commands from the office automation system. The systems and methods herein can be easily updated by wireless or through a port accessible through the rail gasket, as shown as the box to the left in FIG. 1. This can also be the connector for power. These connectors can be daisy-chained through multiple inserts, eventually to a power supply. The power supply can be a converter plugged into a wall socket. It can also be a battery. And this battery could be small and charged by a solar cell either attached to the window insert or outside the building.

FIG. 1 is a schematic illustrating an environmental control device 100 configured with a secondary window 102 that fits on or within a frame 192 of a primary window 190, in embodiments. Primary window 190 includes a glazing 194 and is surrounded by a wall 197 of a building. Secondary window 102 includes a glazing 103 secured in a frame 130, which at least partially surrounds glazing 103. Frame 192 includes jambs 195 (1-4), surfaces of which are oblique to, or perpendicular to, a plane of glazing 194. As fully described in U.S. Pat. No. 11,008,800, frame 130 may be formed of any one or many materials, may be at least partially filled with an insulating material, may be surrounded by various glazing, and surfaces configured to be mated with at least a surface of one jamb 195 of frame 192. Frame 130 may also include a low-emissivity coating on at least one of its cavity-facing surfaces, facing primary window 190, and exterior-facing surface, facing away from primary window 190.

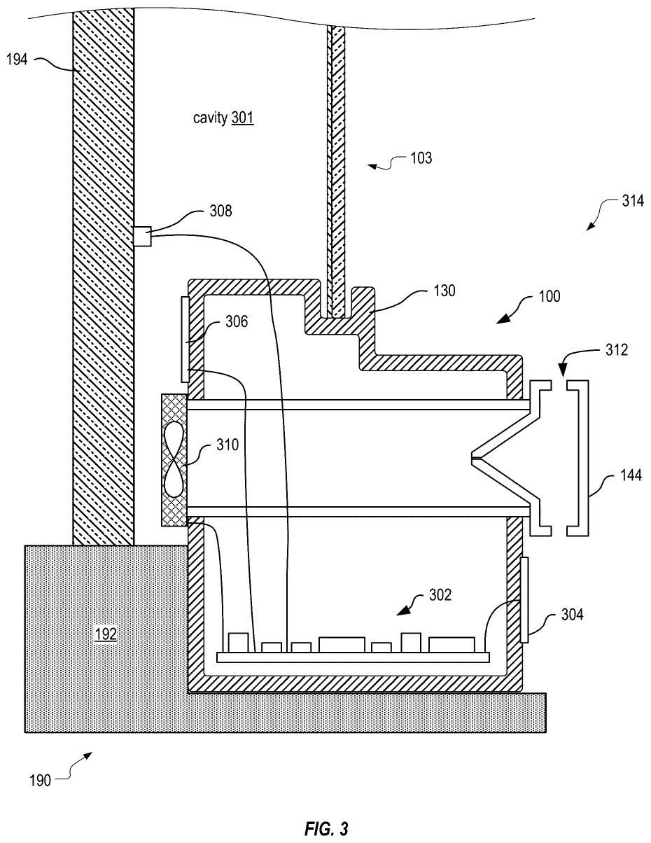

Environmental control device 100 includes an outlet vent 142 and an inlet vent 144. Outlet vent 142 and inlet vent 144 may each be a duck-bill vent, or otherwise a one-way vent without departing form the scope hereof. Outlet vent 142 and inlet vent 144 may be integral with each other, i.e. within the same housing but the single housing having an inlet and outlet, in some embodiments. With larger windows environmental control device 100 may include multiple outlet and inlet vents. Environmental control device 100 may include multiple fans. The fans may also be circular or linear, with linear fans having a more uniform airflow across the surface of the primary window glass. Environmental control device 100 includes other components, such as dust filters (also referred to herein as a gap filter) on either the first vent or the second vent, and/or a moisture filter on either the first vent or the second vent as shown in FIG. 3 and described in detail below.

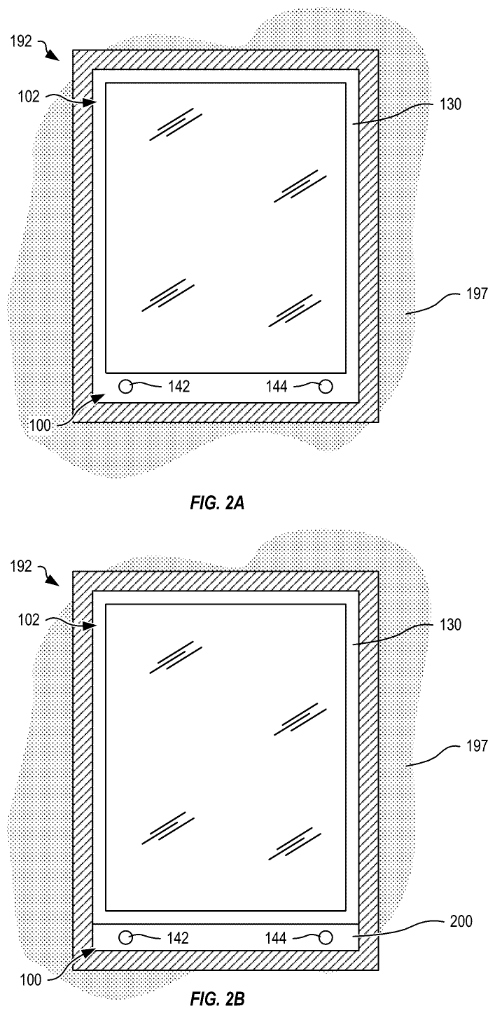

FIG. 2A shows environmental control device 100 integral with secondary window 102, which is mounted to frame 192 of primary window 190 within wall 197. That is, environmental control device 100 is built into frame 130 of secondary window 102. FIG. 2B shows environmental control device 100 of FIG. 1 configured within a housing 200 joined to a bottom side of secondary window 102, in embodiments. Housing 200 may be configured to adjoin any side (e.g., top, left, right, and bottom) of frame 130 without departing from the scope hereof. Housing 200 may sit within a rail of the frame 130. Housing 200 may be configured to retrofit within existing secondary windows, or may be an integral portion of frame 130 during manufacturing of the secondary window and/or frame 130. Environmental control device 100 may be configured with inlet vents and outlet vents in different sides without departing from the scope hereof. This may allow taking advantage of convective flow inside the cavity. Advantageously, since environmental control device 100 has its own housings 200 it may be manufactured independently of secondary window 102 and the manufacturing process of secondary window 102 is unmodified.

FIG. 3 is a cross-section through a portion of environmental control device 100 of FIGS. 1 and 2A, showing a cavity 301 formed between glazing 194 of primary window 190 and glazing 103 of secondary window 102, in embodiments. In this example, environmental control device 100 is configured within a bottom portion of frame 130 and shown mounted to frame 192 of primary window 190.

Environmental control device 100 includes a controller 302 (e.g., a printed circuit board or similar circuitry or discrete logic circuit), a room-side temperature/humidity sensor 304, a cavity-side temperature/humidity sensor 306, a glass temperature sensor 308 thermally coupled with glazing 194 of primary window 190, and a fan 310 positioned on a cavity side of inlet vent 144. Controller 302 may include a processor in operable communication with memory storing computer readable instructions that, when executed by the processor, cause the device 100 to implement the functionality discussed herein. Fan 310 may be integral or separate from inlet vent 144. Fan 310 may be a circular fan or a linear fan. Fan 310 may be one of a plurality of fans 310. Fan 310 may also include an external fan in the primary window frame, and a fan in the secondary window frame.

Outlet vent 142 is shown not including a fan and operated to vent air from within cavity 301 into ambient air 314 of the room, but it may have a fan in certain embodiments. For purposes of illustration, cavity-side temperature/humidity sensor 306 is shown near inlet vent 144; however, cavity-side temperature/humidity sensor 306 may be positioned nearer to outlet vent 142. Room-side temperature/humidity sensor 304, cavity-side temperature/humidity sensor 306, glass temperature sensor 308, and fan 310 are electrically connected (e.g., wired) to controller 302. Outlet vent 142 prevents air flow from cavity 301 to ambient air 314, and inlet vent 144 prevents air flow from ambient air 314 into cavity 301.

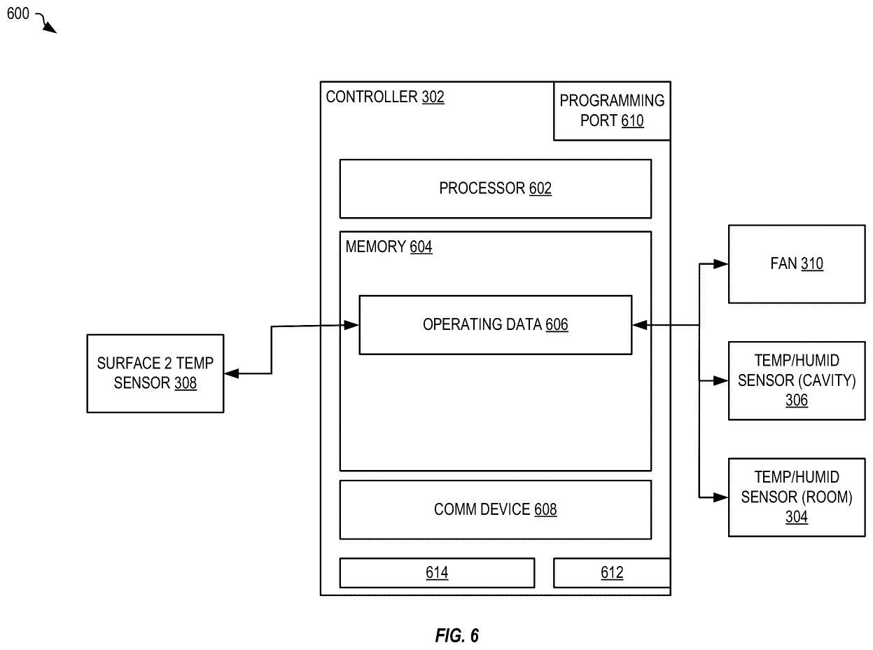

In one example of operation, controller 302 reads (or otherwise receives) temperature and humidity data from room-side temperature/humidity sensor 304 and cavity-side temperature/humidity sensor 306 and an outside glass temperature from glass temperature sensor 308 and generates a control signal for fan 310 based on an algorithm implemented by a controller (see controller 602 of FIG. 6) of controller 302. In certain embodiments, the control signal is binary, turning power to fan 310 on an off, directly from the circuitry or via a controlled relay switch or transistor. In other embodiments, the control signal defines a speed of fan 310, e.g., is a pulse-width modulated signal that controls the amount of power delivered to fan 310. When fan 310 is activated, ambient air 314 from the room-side of secondary window 102 is drawn into an inlet 312 of inlet vent 144 and passes into cavity 301. Since cavity 301 is substantially sealed, air from within cavity 301 is forced out through outlet vent 142.

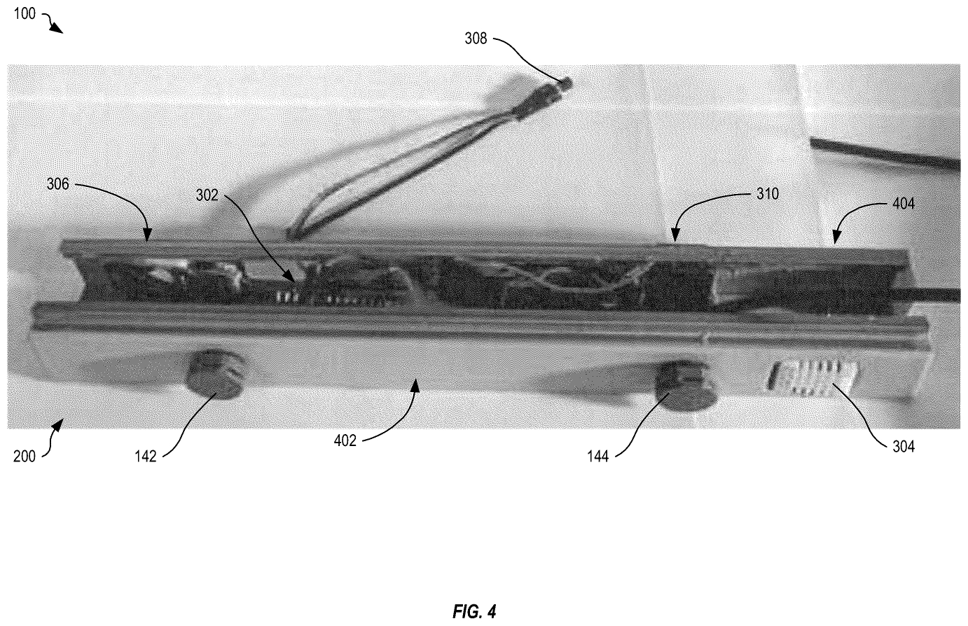

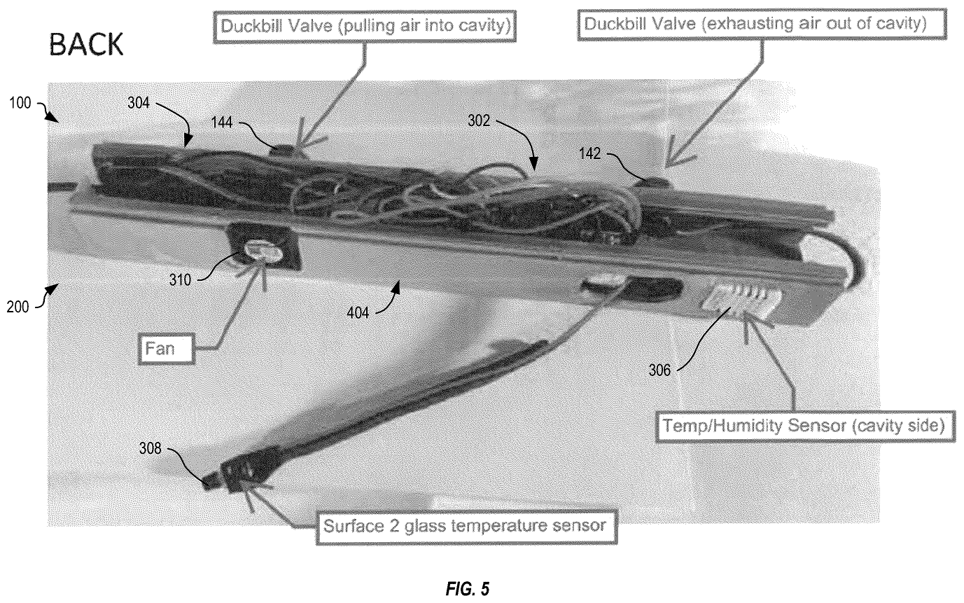

FIG. 4 is a perspective image showing a room-side surface 402 of environmental control device 100 of FIG. 2B, in embodiments. FIG. 5 is a perspective image showing a cavity-side surface 404 of environmental control device 100 of FIG. 2B, in embodiments. FIGS. 4 and 5 are best viewed together with the following description. A top surface of housing 200 is removed to show internal between controller 302, room-side temperature/humidity sensor 304, cavity-side temperature/humidity sensor 306, glass temperature sensor 308, and fan 310. As shown, glass temperature sensor 308 may extend on wires from a cavity-side surface 404 of housing 200.

FIG. 6 is a schematic 600 showing example connectivity of room-side temperature/humidity sensor 304, cavity-side temperature/humidity sensor 306, glass temperature sensor 308, and fan 310 to a controller 602 that includes a processor 602 and memory 604 storing machine-readable instructions that when executed by the processor 602 implement the functionality of environmental control device 100 and in particular the algorithm for controlling humidity within cavity 301 to prevent condensation. Memory 604 may store operating data 606, such as the data from temperature/humidity sensors 304, 306, 308, including calculations discussed herein based thereon, and operating parameters of fan 310.

Controller 302 may further include a communication device 608. Communication device 608 may communicate through Wi-Fi and Bluetooth (or other wired or wireless communication protocols, such as cellular 2G, 4G, 5G, LTE, IoT-NB, Zigbee, ethernet, etc.) with the office automation system to report conditions in the room, the gap, and the S2 surface. Gateways are available to convert this communication to common office automation systems. At least some embodiments of the systems and methods herein can also receive information and commands from the office automation system. The systems and methods herein can be easily updated by wireless or through a port 610 accessible through the rail gasket, as shown as the box to the left in FIG. 1. This can also be the connector for power, or the 302 may include a separate power supply 612. Power supply 612 may be daisy-chained through multiple inserts, eventually to a power supply. The power supply 612 may be a converter plugged into a wall socket. The power supply 612 can also be a battery. And this battery could be small and charged by a solar cell either attached to the window insert or outside the building. Controller 302 may also be in operable communication with a display 614 that is able to display the sensed data from humidity sensor 304, humidity sensor 306, glass temperature sensor 308, and/or fan 310, and/or any other data within operating data 606.

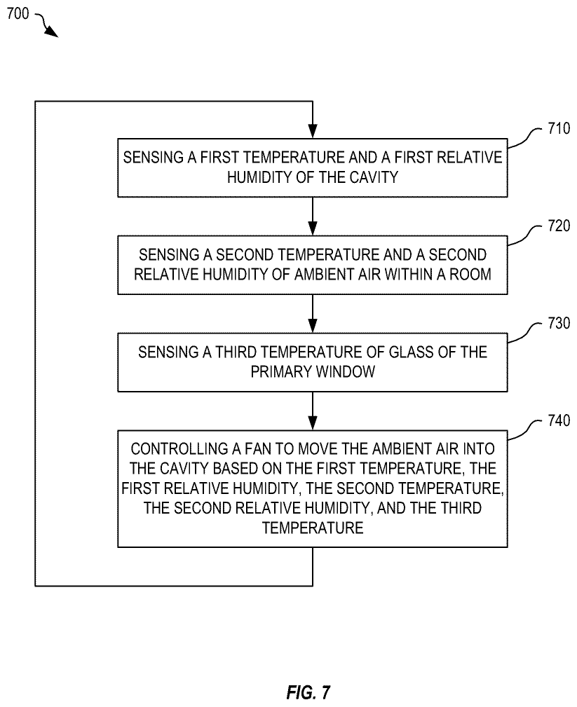

FIG. 7 is a flowchart illustrating one example method 700 for controlling humidity and temperature within cavity 301 formed between primary window 190 and secondary window 102 of FIG. 1, in embodiments. Method 700 is implemented by environmental control device 100, such as using controller 302 of FIG. 3 for example.

In block 710, method 700 senses a first temperature and a first relative humidity of air within the cavity. In one example of block 710, controller 602 reads first temperature and first relative humidity from room-side temperature/humidity sensor 304.

In block 720, method 700 senses a second temperature and a second relative humidity of ambient air within a room. In one example of block 720, controller 602 reads second temperature and second relative humidity from cavity-side temperature/humidity sensor 306.

In block 730, method 700 senses a third temperature of glass of the primary window. In one example of block 730, controller 602 reads the third temperature from glass temperature sensor 308.

In block 740, method 700 controls a fan to move the ambient air into the cavity based on the first temperature, the first relative humidity, the second temperature, the second relative humidity, and the third temperature to prevent condensation forming within the cavity. In one example of block 740, controller 602 controls fan 310 to move ambient air 314 from the room into cavity 301 via inlet vent 144, whereby air from within cavity 301 moves from the cavity 301 to the room via outlet vent 142 when the first temperature, the first relative humidity, the second temperature, the second relative humidity, and the third temperature indicate that condensation may form within cavity 301. In one example of block 740, method 700 controls the fan 310 in response to the temperature and/or humidity being below a dew point threshold. The dew point threshold may be calculated according to Equation (1) above. The dew point threshold may be 2 degrees Fahrenheit above or below the dew point calculated according to equation (1). The dew point may be of the inside surface of the primary window. The dew point threshold may be increased to preemptively avoid condensation. The increasing the dew point threshold may be calculated from the sigma average over multiple temperature measurements, whereby if the average is 2 degrees or less no changes are made to the upper limit, but otherwise the upper limit is set to the average.

In one embodiment of block 740, the fan is controlled based on a water-mass formula, such as Equations (2) and/or (3), above. In embodiments, the water mass formula may be used to lower the dew point threshold when the water-mass in an interior space, that the system 100 is installed in, is lower than the water-mass in the cavity. The above embodiments of block 740 may include the advantage of lowering the dew point of the cavity simply by forcing warmer air into the cavity from the interior space the system 100 is installed in, even when the water-mass in the cavity is the same, or even lower than, the water mass in the interior space the system 100 is installed in. This method affectively attempts to duplicate conditions before the installation of the secondary window.

Blocks 710 through 740 repeat, at intervals for example, to prevent condensation within cavity 301.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. Apparatus for controlling humidity and temperature in a cavity formed between a primary window and a secondary window, comprising:
a housing positioned at one edge of a frame of the secondary window;
a first temperature/humidity sensor positioned on a room-side surface of the housing to sense a first temperature and a first relative humidity of ambient air within a room;
a second temperature/humidity sensor positioned within the cavity to sense a second temperature and a second relative humidity of air within the cavity;
a glass temperature sensor positioned on an internal surface of glazing of the primary window to sense a third temperature of the glass;
a fan;
a first vent positioned within the housing to allow the ambient air to be drawn by the fan into the cavity and to prevent air from the cavity passing into the room;
a second vent positioned within the housing to allow the air within the cavity to pass to the room and to prevent the ambient air from the room to pass into the cavity; and
a controller positioned within the housing to read the first temperature, the first relative humidity, the second temperature, the second relative humidity, and the third temperature and activate the fan to prevent condensation within the cavity.

2. The apparatus of claim 1, comprising one or both of (1) a plurality of the first vents and (2) a plurality of the second vents.

3. The apparatus of claim 1, the fan including a plurality of fans.

4. The apparatus of claim 1, the fan including a circular fan or a linear fan.

5. The apparatus of claim 1, further comprising a dust filter on one or both of the first vent and the second vent.

6. The apparatus of claim 1, further comprising a moisture filter on the first vent.

7. An apparatus for controlling humidity and temperature in a cavity formed between a primary window and a secondary window, comprising:
a housing positioned at one primary frame of the secondary window;
a housing positioned at another second frame of the secondary window;
a first temperature/humidity sensor positioned on a room-side of primary frame of the housing to sense a first temperature and a first relative humidity of ambient air within a room;
a second temperature/humidity sensor positioned within the cavity side of the primary frame of the housing to sense a second temperature and a second relative humidity of air within the cavity;
a glass temperature sensor positioned on an internal surface of glazing of the primary window to sense a third temperature of the glass;
a fan in the primary frame;
a first vent positioned within the of primary frame of the housing to allow the ambient air to be drawn by the fan into the cavity and to prevent air from the cavity passing into the room;
a second vent positioned within a second frame to allow the air within the cavity to pass to the room and to prevent the ambient air from the room to pass into the cavity; and
a controller positioned within the primary frame housing to read the first temperature, the first relative humidity, the second temperature, the second relative humidity, and the third temperature and activate the fan to prevent condensation within the cavity.

8. The apparatus of claim 7, comprising one or both of (1) a plurality of the first vents and (2) a plurality of the second vents.

9. The apparatus of claim 7, incorporating fans in both the primary frame and secondary frame.

10. The apparatus of claim 7, the fan including a circular fan or a linear fan.

11. The apparatus of claim 7, further comprising a dust filter on one or both of the first vent and the second vent.

12. The apparatus of claim 7, further comprising a moisture filter on the first vent.

13. A method for controlling humidity and temperature in a cavity formed between a primary window and a secondary window, comprising:
sensing a first temperature and a first relative humidity of the cavity;
sensing a second temperature and a second relative humidity of ambient air within a room;
sensing a third temperature of glass of the primary window; and
controlling a fan to move the ambient air into the cavity based on the first temperature, the first relative humidity, the second temperature, the second relative humidity, and the third temperature to prevent condensation forming within the cavity.

14. The method of claim 13, the controlling a fan comprising using an advanced dew point formula, more accurate for a broader range of humidity:
$$dew\_point ( degrees F ) = ( 243.12 * ( ln ( humidity / 100. ) + ( ( 17.62 * temp\_c ) / ( 243.12 + temp\_c ) ) ) / ( 17.62 - ( ln ( humidity / 100. ) + ( ( 17.62 * temp\_c ) / ( 243.12 + temp\_c ) ) ) ) ) * 9. / 5. + 32.$$
where temp_c is the temperature inside the cavity in centigrade.

15. The method of claim 14, wherein the dew point is that of the inside surface of the primary window.

16. The method of claim 15, wherein controlling the fan includes turning on the fan when the temperature of the inside surface of the primary window is a threshold amount above, or below, the dew point.

17. The method of claim 15, wherein controlling the fan further comprises increasing the threshold to preemptively avoid condensation.

18. The method of claim 17, where the increasing the threshold is calculated from the sigma average over multiple temperature measurements, wherein if the average is 2 degrees or less no changes are made to the threshold and the threshold is set to the average.

19. The method of claim 13, wherein the controlling the fan includes using a water-mass formula.

20. The method of claim 19, wherein the water-mass formula includes:
$$max\_water \_mass = ( power ( 10 , double ( 5.20389 - 1733.926 / ( temp\_k - 39.485 ) ) ) * 100000 ) \text{} / ( 8.314 * temp\_k ) * 18.02 ;$$
where temp_k is the temperature in kelvin;
water_mass=max_water_mass*humidity.
